(19) United States
(12) Patent Application Publication
(10) Pub. No.: US 2025/0289393 A1
(43) Pub. Date: Sep. 18, 2025

(54) MODULAR LOW-POWER SENSOR HUB SYSTEM FOR VEHICLE MONITORING, SECURITY AND ASSET MANAGEMENT WITH DASHCAM INTEGRATION

(71) Applicant: Nexar Ltd., Tel Aviv (IL)

(72) Inventors: Lev Yitzhak Lavy, Misgav Dov (IL); Likhon Roy, Atlanta, GA (US); Ruben Alexandre Sequeira Sarmento, Porto (PT)

(21) Appl. No.: 19/227,504

(22) Filed: Jun. 4, 2025

(51) Int. Cl. B60R 25/10; B60R 25/102; B60R 25/40

(52) U.S. Cl. CPC B60R 25/1018; B60R 25/102; B60R 25/403

(57) ABSTRACT

A modular sensor for a vehicle, including a central hub including a low-power MCU with BLE communication capability, a power manager including a rechargeable battery and a charger IC, at least one integrated sensor selected from among an accelerometer, a microphone, a reed switch and a smoke detector IC, and at least one external sensor interface connector configured for I2C communication with, and providing power to, one or more external sensor modules, wherein the MCU receives event data from the at least one integrated sensor or from an external sensor module connected via the I2C communication, selectively manages power supplied to the one or more external sensor modules via the external sensor interface connector, and transmits an alert or data to a paired main vehicle dashcam via BLE based on the event data, the main vehicle dashcam configured to orchestrate responses based on the alert or the data.

### FIELD OF THE INVENTION

The present invention relates generally to vehicle monitoring and security systems. More specifically, it pertains to a low-power, modular sensor hub system designed for intelligent integration with a vehicle's dashcam, supporting a diverse array of internal and externally connected sensors for enhanced safety, security and operational awareness.

### BACKGROUND OF THE INVENTION

Vehicles are increasingly equipped with dashcams, and various sensor technologies are available for automotive applications. Existing vehicle telematics, IoT platforms and security systems provide various functionalities. Some systems offer modular sensor components, and dashcams may connect to certain accessories. Bluetooth Low Energy (BLE) beacon technology is also utilized for location and anti-theft purposes, and low-power design with solar assistance has been explored for vehicle accessories.

However, there remains a need for a system that cohesively integrates these aspects into a power-efficient, versatile and user-friendly solution centered around the dashcam as a primary intelligent hub. Challenges persist in providing a truly modular system where a low-power central sensor hub manages and draws data from a wide variety of both internal and easily integrated external I2C-based sensor modules, communicates crucial events to a dashcam via low-energy means, like BLE, for further action, and does so while maintaining extremely low power consumption, potentially augmented by solar charging for extended unattended operation. Furthermore, a system that allows the dashcam to act as the primary orchestrator for this diverse sensor network, configuring the hub and its peripheral sensors, and intelligently responding to their inputs, represents a significant area for improvement. The specific logic for transitioning the hub itself into a network-discoverable beacon under precise conditions, e.g., motion combined with main dashcam unresponsiveness, also warrants further development.

### SUMMARY

The present invention addresses these needs by providing a modular, low-power sensor hub system (the “Nexar Node” or “hub”) specifically architected for deep integration with a vehicle's main connected dashcam. The system uniquely combines a central hub unit featuring its own sensors with robust support for diverse externally connected I2C sensor modules, all managed for minimal power consumption and orchestrated by the dashcam.

The central hub is a compact intelligent device with an integrated low-power microcontroller unit (MCU) and BLE 5.0+ communication. It is designed to operate as a smart intermediary, detecting events via its internal sensors, e.g., accelerometer, microphone, reed switch, smoke detector or via various external sensor modules connected through its I2C-enabled ports. Upon detecting a relevant event, the hub efficiently wakes up the main dashcam using BLE, transmits sensor data and event details, and receives configuration commands from the dashcam. This allows the dashcam to act as the primary control and data processing center for the extended sensor network provided by the hub and its peripherals.

A key aspect of the invention is its system-level power efficiency. The hub incorporates a rechargeable battery, a charger IC and integrated solar panels designed for low-light operation to sustain the hub itself. The hub's MCU also manages power to the connected external I2C sensor modules, enabling or disabling them as needed to conserve overall system energy.

The system architecture supports a wide array of unique use cases through its modularity. External sensor modules, each potentially with a unique I2C address, are easily added or changed, allowing customization for goods monitoring, advanced break-in detection, e.g., specific vibration sensors on windows, presence detectors, SOS button functionality, baby safety monitoring, driver alertness monitoring and child/pet monitoring.

Furthermore, the hub features an intelligent “Air Tag mode” for anti-theft. If the hub detects motion, via its accelerometer, and determines that the main paired dashcam is unresponsive or absent, the hub itself transitions into a BLE beacon mode. This allows other dashcams or supported devices in a wider network to detect and report its location, aiding in asset recovery.

The invention provides a cost-effective, easily configurable and expandable solution that significantly enhances the value and capabilities of a standard vehicle dashcam by transforming it into the command center of a versatile low-power sensory network.

### BRIEF DESCRIPTION OF THE DRAWINGS

FIG. 1 is a schematic block diagram illustrating the architecture of the Nexar Node hub system, including its internal components and interfaces for external sensors and communication with a main dashcam, in accordance with an embodiment of the invention.

### DETAILED DESCRIPTION

The present invention, the “Nexar Node” system, provides a sophisticated yet low-power modular sensor hub. It distinguishes itself from simple sensor tags or generic IoT modules by its deep integration with a vehicle's dashcam, its robust support for a variety of internal and I2C-interfaced external sensor modules, and its comprehensive power management strategy.

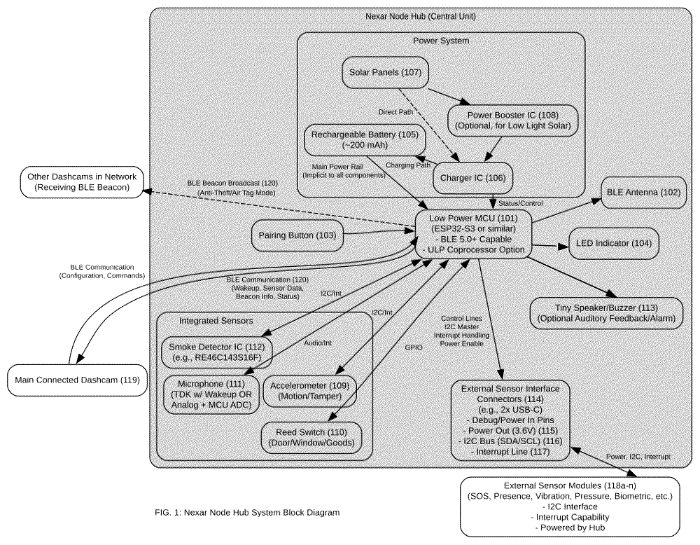

FIG. 1 is a schematic block diagram illustrating the architecture of the Nexar Node hub system, including its internal components and interfaces for external sensors and communication with a main dashcam, in accordance with an embodiment of the invention. The central component is a low-power MCU 101, which includes integrated Bluetooth Low Energy (BLE) 5.0+ capabilities. MCU 101 is connected to a Bluetooth antenna 102 for wireless communication.

User interaction components connected to MCU 101 include a pairing button 103 for initiating Bluetooth pairing, and an LED indicator 104 showing status, such as pairing mode or coupled state.

The power system for the hub includes a rechargeable battery 105, a charger integrated circuit (IC) 106 managing power to the battery, and solar panels 107 for supplementary charging. Optionally, a power booster IC 108 is included to facilitate charging from solar panels in low-light conditions. The power system provides operational power to MCU 101 and to other components.

Integrated sensors connected to or managed by the MCU 101 include an accelerometer 109 for detecting motion and impacts, a reed switch 110 for magnetic field detection, e.g., door/window open, a microphone 111 which may be a microphone with wakeup interrupt, e.g., TDK T5838, or an analog microphone with ADC processing via the MCU for sound detection, and a smoke detector IC 112, e.g., RE46C143S16F, for detecting smoke or gas. Optionally, a tiny speaker/buzzer 113 is connected to MCU 101 for providing auditory feedback or alarms.

MCU 101 interfaces with external sensors through one or more external sensor interface connectors 114, e.g., USB-C. These connectors provide power output 115, e.g., 3.6V, to the external sensors, I2C communication lines 116 (SDA/SCL) for data exchange, and an interrupt line 117 for external sensors to signal the MCU. MCU 101 controls power to these external sensor ports.

Multiple external sensor modules 118a, 118b, . . . , 118n connect to the hub via these interfaces. Each external sensor module 118 typically contains its own specific sensor, e.g., pressure, presence, vibration and I2C interface logic.

MCU 101 uses its BLE capability to communicate with a main connected dashcam 119. This communication includes waking up the dashcam, sending sensor data and receiving configuration commands. The hub also acts as a BLE beacon 120, discoverable by other dashcams in a network.

The overall power management logic, integrated within or controlled by MCU 101 and Charger IC 106 (not shown), manages power distribution, sensor power enabling/disabling, and measurement of power consumed by sensors,

### Key Differentiating Aspects

Dashcam as central orchestrator: Unlike systems where a sensor hub reports to a generic cloud platform or app, the Nexar Node is architected for main vehicle dashcam 119 to act as the primary intelligent controller and data recipient. The dashcam configures hub 101, requests data and initiates actions including inter alia recording, cloud upload and user alerts, based on refined information from the hub's diverse sensor network. This elevates the dashcam's role beyond mere video recording.

Hybrid communication strategy—I2C and BLE: The system employs I2C 116 for robust, efficient and standardized communication between hub 101 and its array of connected external sensor modules 118a-n. This allows for complex data exchange and reliable interrupt handling from these peripheral sensors. Simultaneously, BLE is used for the energy-efficient wireless link between hub 101 and dashcam 119, crucial for event-triggered wakeup and data synopsis.

Comprehensive low-power management: The system emphasizes low power consumption at multiple levels. The hub's MCU 101 is inherently low-power. BLE communication is used for its energy efficiency. Solar panels 107 supplement battery 105 of the hub. Hub MCU 101 controls and selectively powers down connected external I2C sensor modules 118a-n when they are not needed, significantly reducing the power drain of the overall sensor network.

Modular and expandable external sensor ecosystem via I2C: Use of standardized I2C interfaces 116 on external sensor ports 114 allows for a true plug-and-play approach for a wide variety of specialized external sensors 118a-n. Each sensor type has a unique I2C address, enabling automatic identification and tailored interaction by the hub. This contrasts with systems limited to a few proprietary wireless sensors.

Intelligent “air tag mode” logic: The anti-theft beaconing mode is not just a simple periodic broadcast. It is intelligently triggered. The hub's internal accelerometer 109 detects motion, and MCU 101 then ascertains if the main paired dashcam 119 is present and responsive. Only if the dashcam is unresponsive, suggesting that the hub may be moving without the primary vehicle system, or the dashcam is disabled/stolen, does hub 101 activate its BLE beacon mode 120 to be discoverable by a wider network of other dashcams.

Central hub (Nexar Node) architecture and components: The central hub is a small smart device designed as a low-power and low-maintenance solution for vehicle security and added intelligence.

Key architectural features and components of the hub include physical characteristics. The size of the hub is designed to be compact, with dimensions preferably not exceeding 4.0 cm×4.0 cm×2.0 cm. The hub is intended to be mounted with a transparent mounting sticker for unobtrusive placement within a vehicle.

Core electronics include MCU 101, which is a low-power microcontroller unit with Bluetooth 5.0 capabilities or a subsequent version, e.g., an ESP32-S3 with ULP options. A Bluetooth antenna 102 is positioned to allow effective transmission and reception from various orientations within a vehicle. A pairing mechanism 103 uses a physical button to allow the device to enter Bluetooth pairing mode. An LED indicator 104 shows Bluetooth coupling status and potentially other operational states.

Power management includes rechargeable battery 105, which is an internal rechargeable battery, for example, with a capacity of approximately 200 mAh. Charger IC 106 is an integrated circuit for managing charging of the rechargeable battery. Integrated solar panels 107 charge the hub, designed to be effective even in low-light conditions. Optional power booster IC 108 optimizes charging from the solar panels, especially in low ambient light. Sensor power control allows USB hub MCU 101 to enable or disable power to each connected external sensor module and disconnect it from the power supply to limit power consumption. It may also measure the power consumed by each sensor. Sensor voltage supply 115 provides a common voltage, e.g., 3.6V, from its power IC to operate the connected external sensor modules.

Integrated sensors include internal accelerometer 109, which detects tampering, motion and impacts. Reed switch 110 is used as a sensor for window/door openings, with an external magnet, or for goods monitoring by detecting removal of an object with an attached magnet. Internal microphone 111, such as a TDK microphone with wakeup interrupt capability, or an analog microphone whose output is monitored by the MCU's ADC, e.g., using the ULP option of an ESP32-S3, detects specific sound events like glass breaking. Integrated smoke detector IC 112 IC, e.g., RE46C143S16F, detects smoke or other hazardous airborne particles. Optional auditory feedback 113 in the form of a tiny speaker or buzzer provides auditory feedback, alerts or alarms.

External sensor interfaces 114 include two USB-C connectors, or other suitable multi-pin connectors. These connectors are designed to share debug and power input pins for the hub itself, while also providing power output and communication lines for external sensor modules. Each connector powers at least one external sensor module and communicates with it using I2C bus 116. Interrupt wire 117 is also supported for each external sensor channel. I2C is the primary communication protocol for data exchange with external sensor modules. Instead of I2C, analog input is supported for simple sensors where no I2C is detected.

External sensor modules 118a-n are designed to be compact, low-power devices that extend the sensing capabilities of the Nexar Node hub.

Each sensor module communicates with hub 101 using I2C protocol 116. Each sensor module is powered by voltage, e.g., 3.6V, supplied by hub 115 through the connecting cable. Each sensor module activates an interrupt line 117 to the hub to signal an event or availability of data. The acquired data is then transferred via I2C. The cable connecting external sensors to the hub carries power, the interrupt wire, and the two I2C data bus wires (SDA, SCL). Each sensor device type should ideally have a unique I2C address or other identification mechanism that allows the hub to automatically identify it. When dedicated I2C lines per channel (connector) are used, multiple instances of the same sensor type, each to a different port, are connected.

Nexar Node hub 101 operates in a low-power state, waking its MCU core functions only upon sensor triggers or for scheduled BLE communication with main dashcam 119.

When an internal sensor (109, 110, 111, 112) or an external sensor module (118a-n) detects an event that meets predefined criteria, e.g., a specific sound level, motion threshold, reed switch state change, or I2C interrupt from an external module, the relevant sensor or module triggers an interrupt, either internal to the MCU for integrated sensors, or via line 117 for external modules.

The hub's MCU 101 wakes up fully, identifies the source sensor, via internal logic or by reading the I2C bus after an external interrupt, and reads relevant data from the sensor. Based on the nature of the event and rules, that are configured by dashcam 119, hub 101 may activate its BLE communication to wake up the paired main dashcam 119, transmit event data and sensor readings to dashcam 119, trigger a local alarm via its buzzer/speaker 113, log the event internally if communication fails, and/or when motion is detected and the dashcam is unresponsive, enter the BLE beacon mode 120. Main dashcam 119, once awakened and informed by hub 101, then takes further actions, including inter alia starting video recording, if not already active in a parking mode, saving event footage, uploading data and alerts to a cloud service, sending notifications to the user's smartphone, or interfacing with emergency services via a connected telematics unit if available.

Power management is a cornerstone of the system. Hub 101 selectively powers down external I2C sensor modules 118a-n, and its own MCU's low-power operational modes. Supplementary solar charging 107 contributes to extended operational life without significantly draining the vehicle's main battery, making it suitable for long-term parked vehicle monitoring.

Modularity via I2C 116 allows for a customizable sensor array tailored to specific user needs or vehicle types. The interface, with unique addressing for different sensor types, simplifies addition and identification of new sensor modules in the future, making the system adaptable and future-proof.

### Use Cases

Nexar Node, through its integrated sensors and its ability to connect a variety of external sensor modules, supports a wide array of use cases, Some use cases are fulfilled by the Nexar Node hub alone, while others leverage small external devices that communicate with the hub.

### Goods Monitoring

Nexar Node detects if mobile tools or other valuable objects are moved, particularly in open vehicles like pickup trucks. This may leverage a network of Nexar-equipped vehicles to report events. Nexar Node's integrated reed switch 110 is used together with a magnet attached to the object being monitored. If the object is picked up, a magnetic field change is detected. An optional disarming button or keypad, which is an external module or integrated with the dashcam app, is used to prevent false alarms.

Application for general goods is achieved using a similar approach to intrusion detection, where accelerometer 109 detects motion or disturbance of the goods area or attached to the goods itself.

### Break-In Detection: Window Break

The hub's integrated microphone 111 detects a characteristic sound of a vehicle window breaking or wakes up the unit for further analysis using the dashcam. MCU 101 processes audio input from microphone 111. Algorithms identify acoustic signatures associated with glass shattering. Upon detection, the hub wakes up the dashcam 119.

Another window break use case involves a thin external vibration sensor module adhered to vehicle windows to detect either break-in attempts, e.g., striking the glass, or impacts like fender benders while the vehicle is parked. This is an alternative or supplement when the hub's internal microphone 111 is insufficient for all scenarios. An external module with an I2C accelerometer on a tiny PCB, or a specialized vibration-sensitive microphone, e.g., TDK T5838 with interrupt capability, is attached to a glass surface. Vibrations or impacts exceeding a threshold trigger an interrupt 117 to hub 101. The hub is instructed by the main dashcam 119 to disarm this sensor when the vehicle is in motion to prevent false positives and conserve power.

### Break-In Detection: Door/Window Open

Nexar Node detects unauthorized opening of doors or windows, especially when the vehicle is parked. This is particularly useful for cargo vehicles, yet applicable to any passenger vehicle.

The hub's integrated reed switch 110 is installed on a door or window frame, with a corresponding magnet on the moving part of the door or window. Opening the door/window separates the magnet from the switch, triggering a detection.

### Smoke/Gas/Smell Sensor

Another use case using the Nexar Node includes smoke/gas detection. The Nexar Node operates similar to a standard smoke detector, but for in-vehicle use to detect smoke from fire, unusual or hazardous smells, air impurities, gas leaks, toxic fumes or flammable liquids. The integrated smoke detector IC 112, e.g., RE46C143S16F, monitors the air quality. Upon detecting harmful gases or smoke particles, hub 101 triggers an alarm, if equipped with buzzer 113, and/or wakes up dashcam 119 to notify the user or emergency services.

### SOS Button

This use case involves external sensor modules 118a-n. An external I2C module with typically three buttons, e.g., SOS, Event, Talk, is used in case of emergency, installed within easy reach of the driver. An external module uses a low-power I2C I/O expander, e.g., NXP PCA9536, to interface the buttons. Each button press triggers an interrupt 117 to hub 101, which then queries the module via I2C 116 to determine which button was pressed. LEDs on the module indicate transmission. Optionally, a proximity sensor, e.g., Microchip AT42QT1010 controlled by the PCA9536, on the module detects the driver's hand approaching, and illuminate the buttons for night-time visibility.

### Break-In Intrusion Detection

An external presence detector module provides notification if, for example, someone leaves a window open and an intruder attempts to enter or take something out of the car. An optional tiny loud buzzer for alarm is part of hub 113 or the external module.

An external module incorporating a low-power presence or proximity sensor IC, e.g., an Acconeer A111 pulsed coherent radar sensor, communicates detected presence via I2C 116 to hub 101 after triggering an interrupt 117.

### Baby Safety/Child Presence Detection

A low-power external pressure sensor module is installed on a car seat, and detects presence of a baby or small child seated in the car. An external I2C module incorporates a low-power MCU and a pressure sensor, e.g., similar to the Joy-IT SEN-Pressure10. It communicates presence information, e.g., baby detected/not detected, to hub 101 via I2C 116 typically after an interrupt 117 signals a change in state.

### Driver Alertness Monitoring

External biometric sensor modules are connected to, for example, the steering wheel to monitor if a driver is falling asleep, e.g., detecting a loosening grip, or showing other signs of incapacitation. Adding pressure sensors to the pedals is used to detect driver alertness, giving a warning if feet are off the pedals without cruise control active. For steering wheel grip/ECG-like monitoring, an external module with a suitable sensor IC, e.g., AD8232 for heart rate monitoring through hand contact, and a low-power I2C MCU. Electrodes are integrated into the steering wheel. For pedal pressure, external pressure sensor modules, similar to the baby safety sensor, are placed on the accelerator and/or brake pedals. Data is sent from these modules to hub 101, which then relays critical alerts to dashcam 119 or triggers local warnings.

### Child and Pet Monitor for Parked Cars

Similar to the intruder sensor, an external sensor module detects movement and presence of a child or a pet left inside a parked car. This is used to trigger interior-facing camera data, if available through the dashcam system, and to update the user on the status. An external presence/motion sensor module, e.g., using A111 radar technology or a PIR sensor, is positioned to monitor the vehicle's interior. Detection of movement triggers an interrupt 117, prompting hub 101 to wake dashcam 119, which streams Interior footage, if capable, or sends an alert to the user.

### Garage Parking Assist

Various simple external sensors are used inside a garage to help an arriving car park safely. This is used in tandem with the vehicle's own road and rear-facing cameras, a dedicated garage camera, or with distance sensors connected to the hub to aid in safely parking the vehicle. Hub 101 uses BLE to detect proximity to special “garage mode” beacons, or alternatively this mode is manually activated. Upon entering garage mode, the hub activates external distance sensors, e.g., ultrasonic or IR sensors, connected to it. These sensors provide distance information to assist the driver, displayed via the screen of dashcam 119 or a companion app. Vehicle cameras are also activated by the dashcam.

### Air Tag Mode/Anti-Theft Mode (Hub as Beacon)

If motion is detected by the hub's accelerometer 109, and main dashcam 119 is not responding or absent, indicating potential theft of the hub or the item attached to it, or that the dashcam system is powered down/compromised, hub unit 101 itself transitions into a BLE beacon mode 120. Hub 101 continuously broadcasts a unique BLE identifier. Other nearby dashcams in the Nexar network, or a compatible network, detect this beacon, retrieve its ID and report its location, based on the detecting dashcam's GPS, to a central server, allowing the owner to track the hub's location.

What is claimed is:

1. A modular sensor system for a vehicle, comprising a central hub comprising:
a low-power microcontroller unit (MCU) with Bluetooth Low Energy (BLE) communication capability;
a power management system comprising:
a rechargeable battery; and
a charger integrated circuit (IC);
at least one integrated sensor selected from the group consisting of an accelerometer, a microphone, a reed switch and a smoke detector IC; and
at least one external sensor interface connector configured for inter-integrated circuit (I2C) communication with, and providing power to, one or more external sensor modules,
wherein said MCU is operable to:
receive event data from said at least one integrated sensor or from an external sensor module connected via I2C communication;
selectively manage power supplied to the one or more external sensor modules via said at least one external sensor interface connector; and
transmit an alert or data to a paired main vehicle dashcam via BLE based on the event data, the main vehicle dashcam being configured to orchestrate responses based on the alert or the data.

2. The system of claim 1, wherein said power management system further comprises integrated solar panels charging said rechargeable battery.

3. The system of claim 2, wherein said power management system further comprises a power booster IC to enhance charging from said solar panels in low-light conditions.

4. The system of claim 1, wherein said central hub further comprises:
a user-operable button for initiating BLE pairing; and
an LED indicator for displaying pairing status.

5. The system of claim 1, wherein said at least one external sensor interface connector comprises at least two USB-C connectors, each supporting I2C communication, power delivery and an interrupt line for distinct external sensor modules.

6. The system of claim 1, wherein said at least one integrated sensor comprises:
an accelerometer;
a microphone configured for sound event detection;
a reed switch, and
a smoke detector IC.

7. The system of claim 1, wherein said MCU is further operable to, upon detection of motion by an integrated accelerometer and determination that the main vehicle dashcam is unresponsive or absent, activate a BLE beacon mode to broadcast a unique identifier from said central hub.

8. The system of claim 1, further comprising at least one external sensor module connecting to said at least one external sensor interface connector, the external sensor module comprising:
a specific function sensor; and
an I2C interface for communication with said MCU, the external sensor module being powered by said central hub.

9. The system of claim 8, wherein said external sensor module is selected from the group consisting of an SOS button module, a presence detection module, a window vibration sensor module, a child car seat pressure sensor module, and a driver biometric sensor module.

10. The system of claim 8, wherein said external sensor module is configured to transmit an interrupt signal to said MCU via the interrupt line upon detecting an event specific to its function.

11. The system of claim 1, wherein either said microphone comprises a MEMS microphone with a wakeup interrupt output connected to said MCU, or said MCU is configured to periodically sample an analog output of said microphone using an analog-to-digital converter in a low-power mode, to detect sound events.

12. The system of claim 1, wherein said central hub has physical dimensions not exceeding 4.0 cm×4.0 cm×2.0 cm and is mountable via a transparent adhesive sticker.

13. The system of claim 1, wherein said MCU is further operable to wake up the main dashcam, on wakeup or event detection, and in turn the main dashcam aggregates an alert and data for transmission to the dashcam owner via cellular modem on the dashcam.

14. A method for vehicle monitoring using a modular sensor hub system, comprising:
providing a central hub comprising a low-power microcontroller unit (MCU) with Bluetooth Low Energy (BLE) communication capability, a power management system including a rechargeable battery, at least one integrated sensor and at least one external sensor interface connector configured for inter-integrated circuit (I2C) communication and power delivery;
connecting at least one external sensor module to the at least one external sensor interface connector;
detecting an event using the at least one Integrated sensor or the at least one external sensor module;
processing event data within the MCU;
selectively managing power by the MCU to the at least one external sensor module; and
transmitting, via BLE from the MCU, an alert or processed data to a paired main vehicle dashcam, enabling the dashcam to initiate further action.

15. The method of claim 14, further comprising:
detecting motion using an accelerometer integrated within the central hub unit;
determining, by the MCU, if the main vehicle dashcam is unresponsive or absent; and
when the main vehicle dashcam is determined to be unresponsive or absent, activating, by the MCU, a BLE beacon mode in the central hub to broadcast a unique identifier.
